(19) United States
(12) Patent Application Publication
(10) Pub. No.: US 2013/0202757 A1
(43) Pub. Date: Aug. 8, 2013

(54) APPARATUS FOR AERATING AND FILTERING WINE

(71) Applicant: Nathaniel HAWKINS, Greensboro, NC (US)

(72) Inventor: Nathaniel HAWKINS, Greensboro, NC (US)

(21) Appl. No.: 13/760,106

(22) Filed: Feb. 6, 2013

Related U.S. Application Data
(60) Provisional application No. 61/595,324, filed on Feb. 6, 2012.

(51) Int. Cl. B01F 3/04; C12G 1/00

(52) U.S. Cl. CPC B01F 3/0446; C12G 1/005
USPC 426/474; 99/323.1

(57) ABSTRACT

An apparatus for aerating and filtering wine from a bottle includes a first end for receiving at least a portion of the bottle. The apparatus additionally includes a second end defining a chamber for receiving the wine. The chamber is in fluid communication with the bottle. The apparatus further includes an intermediate portion for filtering and aerating the wine as the wine passes from the bottle, through the apparatus and to the chamber.

### CROSS-REFERENCE TO RELATED APPLICATIONS

This application claims the benefit of U.S. Provisional Application No. 61/595,324, filed on 06 Feb. 2012. The entire disclosure of the above application is incorporated herein by reference.

### FIELD

The present disclosure generally relates to the aeration and filtering of wine. More particularly, the present disclosure relates to an apparatus for aerating and filtering wine.

### BACKGROUND

This section provides background information related to the present disclosure which is not necessarily prior art.

It has long been appreciated that the taste and enjoyment of wine may be enhanced with sufficient aeration and proper filtering. Through aeration, the flavor profile of wine may soften and mellow and the overall flavor characteristic may improve. Typically, red wines are most in need of “aeration” or “breathing” before serving. There are certain white wines, however, that may also improve with air exposure.

Simply uncorking a bottle of wine is generally not sufficient to adequately aerate. There is not enough surface area of the wine at the top of the bottle to permit enough air to make contact with the wine. Thus, wine is frequently decanted prior to serving.

In addition to simple decanting, various devices are known for aerating wine. For example, devices are known which affix to the tip of the wine bottle so as to aerate while pouring. Also known are electronic or other devices which pump air into the bottle of wine. Still further, funnel type devices are known where wine is poured through over the glass. While various devices have been heretofore proposed for the aeration or filtering of wine, a continuous need for improvement in the relative art remains.

### SUMMARY

This section provides a general summary of the disclosure, and is not a comprehensive disclosure of its full scope or all of its features.

According to one particular aspect, the present teachings provide an apparatus for aerating and filtering wine from a bottle. The apparatus includes a first end for receiving at least a portion of the bottle. The apparatus additionally includes a second end defining a chamber for receiving the wine. The chamber is in fluid communication with the bottle. The apparatus further includes an intermediate portion for filtering and aerating the wine as the wine passes from the bottle, through the apparatus and to the chamber.

According to another particular aspect, the present teachings similarly provide an apparatus for aerating and filtering wine from a bottle. The apparatus includes a first end for insertion into an opening of the bottle. The apparatus additionally includes a second end for coupling with a secondary container. The apparatus further includes a central portion for filtering and aerating the wine as the wine passes from the bottle, through the apparatus and to the chamber.

According to yet another particular aspect, the present teachings provide a method for aerating and filtering wine from a bottle. The method includes providing an apparatus including a first end, a second end and an intermediate portion. The method additionally includes engaging the first end with the wine bottle and engaging the second end with a secondary container. The method further includes transferring the wine from the bottle, through the apparatus and to the secondary container so as to filter and aerate the wine as the wine passes through the apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an apparatus for aerating and filtering wine in accordance with the present teachings, the apparatus shown operatively associated with a bottle of wine;

FIG. 2. is a perspective view of the apparatus for aerating and filtering wine of FIG. 1, the apparatus for aerating and filtering wine shown separated from the wine bottle for purposes of illustration;

FIG. 2A is a side view of the apparatus for aerating and filtering wine and the wine bottle of FIG. 1;

FIG. 3 is a cross-sectional view taken along the line A-A.

FIG. 4 is a side view of another apparatus for aerating and filtering wine in accordance with the present teachings, the apparatus incorporating a fluid flow nozzle portion substantially identical to corresponding structure of the apparatus of FIGS. 1-3;

FIG. 5 is a perspective view of the apparatus for aerating and filtering wine of FIG. 4, the apparatus for aerating and filtering wine illustrated with the rubber sleeves of FIG. 4 removed for purposes of illustration;

FIG. 6 is a side view of the apparatus for aerating and filtering wine of FIG. 5; and

FIG. 7 is an end view of the apparatus for aerating and filtering wine of FIG. 4.

Corresponding reference numerals indicate corresponding parts throughout the several views of the drawings. It will be understood that the various elements are drawn to scale throughout the views.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

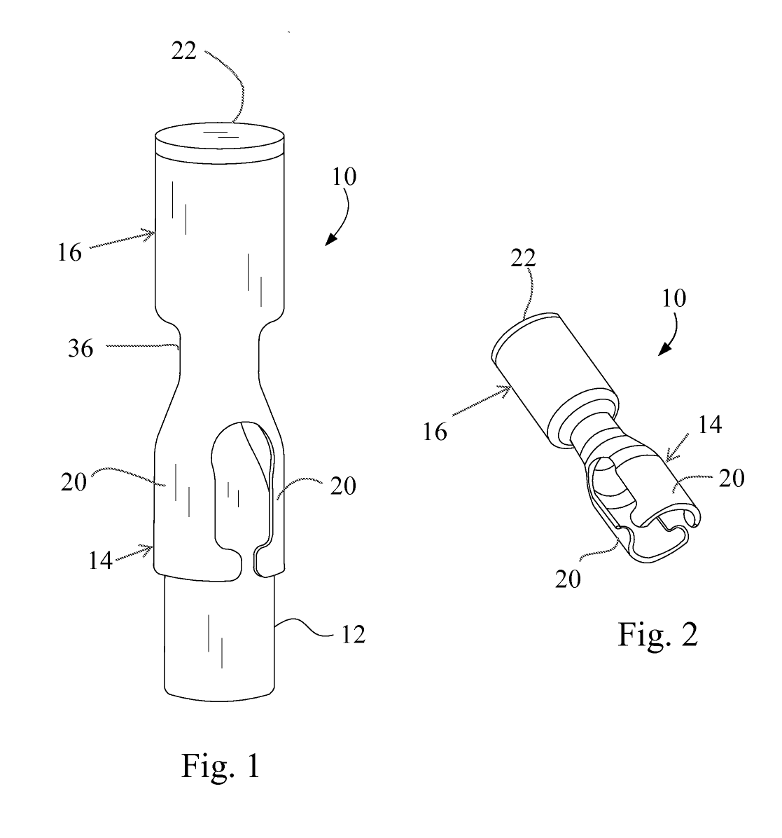

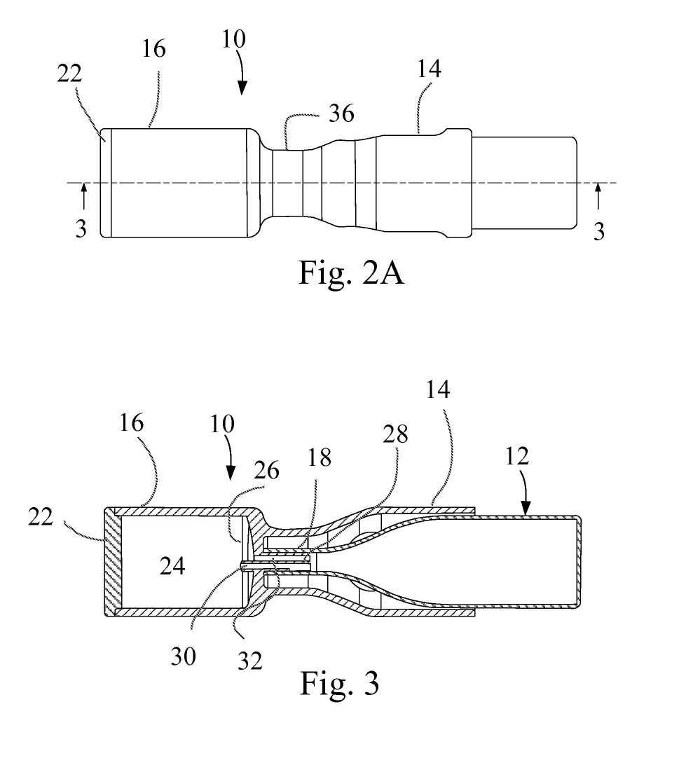

With initial reference to FIGS. 1-3, an apparatus for aerating and filtering wine in accordance with the present teachings is illustrated and generally identified at reference character 10. The apparatus is shown in FIGS. 1 and 3 operatively associated with an exemplary bottle of wine 12. It will be understood that the bottle of wine 12 is conventional in construction. In the embodiment illustrated, the bottle is a 750 ml bottle of wine. Those skilled in the art, however, will appreciate that the present teachings are not so limited.

The apparatus 10 is illustrated to generally include a first end 14, a second end 16 and an intermediate or central portion 18. In the embodiment illustrated, the apparatus 10 is unitarily constructed to include the first end 14, the second end 16 and the intermediate portion 18. For example, the first end 14, the second end 16 and the intermediate portion may be unitarily constructed of plastic or other suitable material.

The apparatus 10 slides over the top of the bottle of wine 12. In this regard, the first end or lower portion or lower end 14 is illustrated to include a pair of spaced apart arms 20. The spaced apart arms 20 are adapted to flex slightly relative to one another to accommodate the bottle 12. Explaining further, the first end 14 is designed to have an interference fit with the width of the bottle 12, and may flex (as a leaf spring) to hold itself to an outer diameter of the bottle 12. The first end 14 allows the apparatus to fit over a variety of bottles 12.

The second end 16 or upper end is intended to receive the liquid contents of the wine bottle 12 when these contents are aerated and filtered. The second end 16 is designed to be sealed from liquid leakage and may include a removable cap or lid 22 for cleaning. In the embodiment illustrated, the second end 16 defines a chamber 24 designed to hold at least 750 ml (e.g., more than the full contents of a full size bottle 12 of wine). In other applications, the chamber 24 may have a greater or lesser capacity depending on the intended use of the apparatus 10. At the bottom of the second end, there may be provided a filter over the return “drain.” This filter is intended to filter particles, sediment, and crystals from the wine, which can naturally occur. The second end 16 defines a flat surface for supporting the bottle 12 when the bottle 12 is inverted.

The intermediate portion 18 of the apparatus 10 will be described with particular reference to the cross-sectional view of FIG. 3. The intermediate portion or central portion 18 may be generally cylindrical. An outer diameter of the intermediate portion 18 may be received within the opening of the bottle 12. A generally cylindrical opening or through bore may extend through the intermediate portion. This opening may be divided by a longitudinally extending central wall 28 which defines a first channel 30 and a second channel 32. The first and second channels 30, 32 may be generally parallel to one another. As wine exits the bottle, the first channel 30 may allow the passage of wine and the second channel 32 may allow the passage of air. As addressed below, the exit port for the first channel 30 is lower than the exit port for the second channel 32 when the bottle 12 is invented. As a result, a higher liquid pressure over the first channel 32 initiates downward flow of the wine through the first channel with gravity, rather than air flow. On the side proximate the second end 16, the first channel 30 extends beyond the second channel 32 and thereby extends into the chamber 24. As illustrated, the first channel terminates at a cylindrical wall defining an end of the chamber 24.

The apparatus 10 is designed to be placed on top of the bottle 12 of opened wine, as shown in FIG. 1. Then, the apparatus 10 and the bottle 12 are inverted by the user and the contents (e.g., wine) enters the chamber 24. The nozzle or intermediate portion 18 is designed to allow wine to flow through one channel 30 wholly and air through the other channel 32 when wine exits the bottle 12. When full, the bottle 12 is returned to the natural upright position. The wine may flow through the filter 26. In an opposite manner, the wine returns to the bottle 12 through the second channel 32 as the second channel 32 sits lower than the first channel 30 when the bottle 12 is returned to its upright position. The wine is mixed with air during both steps and introduces oxygen to the fluid. The flow of the wine into the chamber 24 is at the center of the circular cross section of the apparatus 10. The wine flow via gravity in the middle of the wine pool creates the most desirable aeration, as the velocity of the falling wine is sufficient to introduce large quantities of air to the liquid.

The center diameter 36 is more narrow than the rest of the apparatus 10 in order for the user to be able to hold with one hand by forming a “C” shape with their thumb and fingers. As noted above, the apparatus 10 has a flat cap 22 to allow the apparatus 10 to sit in the upright position on a counter either right side up or upside down.

The intermediate portion 18 is designed with two channels 30, 32 to separate air and fluid flow. It is also designed to maximize flow within a predetermined diameter (the neck of a wine bottle). The exit ports may have screens or multiple holes in another embodiment, in order to dissipate the air or fluid flowing through in order to better aerate.

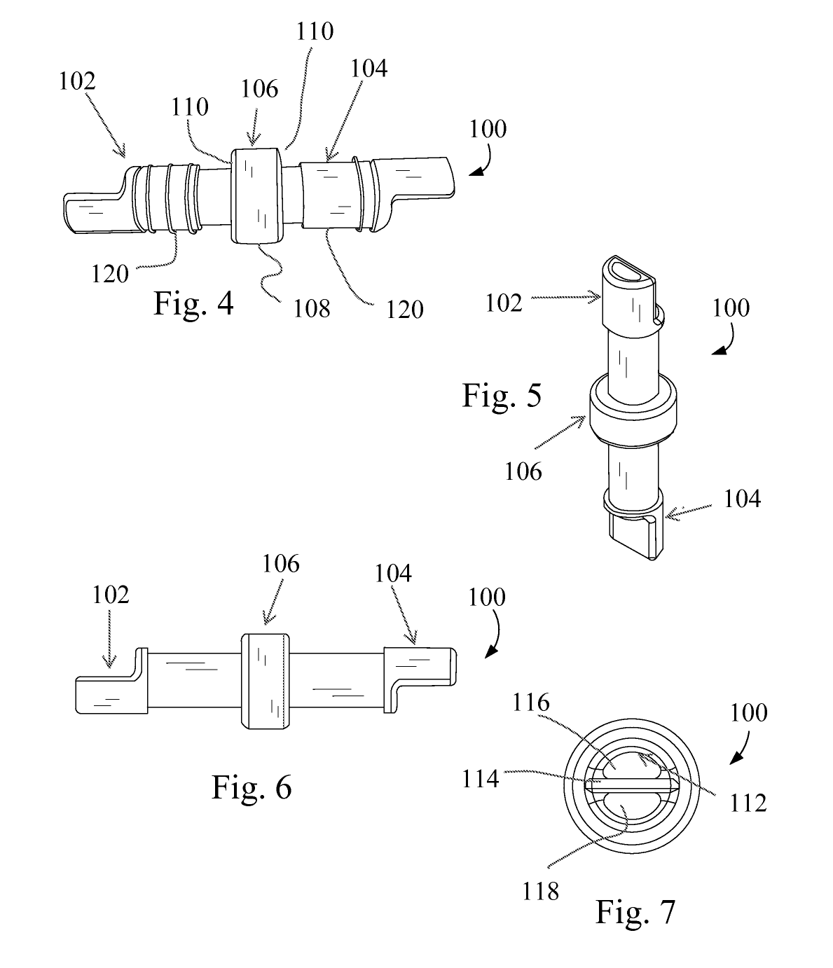

Turning to FIGS. 4-7, another apparatus for aerating and filtering wine is illustrated and generally identified at reference character 100. The apparatus 100 differs from the apparatus 10 in that it does not include a receptacle or chamber for receiving the contents of the bottle 12. Rather, the apparatus 100 may be removable coupled to a secondary container (e.g., a second, empty wine bottle) for at least temporarily receiving the wine from the bottle 12 as the wine is being aerated and filtered. It will be understood that the portions of the apparatus 100 that aerate and filter the wine are substantially identical to corresponding portions on the apparatus 10 to the extent not otherwise described herein.

The apparatus 100 is illustrated to generally include a first end 102, a second end 104 and a central or intermediate portion 106. In the embodiment illustrated, the apparatus is unitarily formed of plastic or other suitable materials.

The intermediate portion or central portion 106 may be generally cylindrical. An exterior of the central portion 106 may include a middle section of increased diameter 108. This middle section may be bounded by a pair of radially extending faces 110. These faces 110 may abut a bottle, for example. A generally cylindrical opening or through bore 112 may extend through the intermediate portion 106. This opening 112 may be divided by a longitudinally extending central wall 114 which defines a first channel 116 and a second channel 118. The first and second channels 116, 118 may be generally parallel to one another. When wine is poured from a first bottle to a second bottle, the first channel 116 may allow the passage of wine and the second channel 118 may allow the passage of air. On the side proximate the first end 102, the second channel 118 extends beyond the first channel 116. On the side proximate the second end 104, the first channel 116 extends beyond the second channel 118. It will be understood that the apparatus 100 is effectively symmetrical about the intermediate portion 106.

The apparatus 100 is designed to be placed in an open end of a first wine bottle 12. Either end 102 or 104 may be placed in the first bottle 12. The bottle 12 with the apparatus 100 in place is then inverted with the second end 104 of the apparatus 100 engaged with a second bottle. In this manner, wine from the first bottle passes through the apparatus 100 and enters a chamber of the second bottle.

Similar to the discussion above regarding the apparatus 10, the nozzle or intermediate portion 106 of the apparatus 100 is designed to allow wine to flow through the first channel 116 wholly and air through the second channel 118 when the first bottle is inverted. When the wine is in the second bottle, the bottles and the apparatus 100 are next flipped over such that the original or first bottle is on the bottom and wine returns to the original bottle. Now, the intermediate portion 106 functions to allow wine to flow through the second channel 118 wholly and air through the first channel 116. In both steps, the wine flows through the lower exit port under the force of gravity. The wine is mixed with air during both steps and oxygen is introduced to the fluid. The wine flow via gravity within the apparatus 100 creates the most desirable aeration, as the velocity of the falling wine is sufficient to introduce large quantities of air to the liquid. The exit ports may have screens or multiple holes to dissipate the air or fluid flowing through in order to better aerate and/or filter the wine.

As shown in FIG. 4, the apparatus 100 may include rubber grooved sleeves 120. These sleeves 120 seal the fluid from leaking from the bottle 12 or the secondary container while the apparatus 100 functions. While not illustrated, it will be understood that the apparatus 10 may include a similar rubber grooved sleeve for sealing to the bottle 12.

In both embodiments 10 and 100, the stepped down exit ports allow liquid to sit lower in the chamber over one of the channels. This creates higher liquid pressure over this channel and initiates fluid flow downward with gravity, rather than air flow. The opposite is true in the lower chamber, where upward air pressure floats to the higher channel due to the step down. This is designed to be the opposite channel from the fluid channel travelling down. This design works in reverse as the bottle is flipped over. In relation to vertical height, the channel with the lower inlet results in liquid flow due to a higher hydrostatic pressure, and the higher channel results in air flow due to lower liquid hydrostatic pressure.

Accordingly, two embodiments of an apparatus 10 and 100 for the aeration and filtering of wine are provided. In one embodiment, the apparatus 10 has an enclosed chamber that may be placed in fluid communication with a wine bottle. In another embodiment 100, a second chamber is provided by a second wine bottle. The apparatus 10 allows the wine bottle to be inverted. Both embodiments 10 and 100 provide a two-way nozzle used for fluid transfer between chambers. A capturing mechanism is incorporated into the apparatus 10 and used for holding the apparatus 10 to the exterior of the bottle 12.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for aerating and filtering wine from a bottle, the apparatus comprising:
a first end for receiving at least a portion of the bottle;
a second end defining a chamber for receiving the wine, the chamber in fluid communication with the bottle; and
an intermediate portion for filtering and aerating the wine as the wine passes therefrom from the bottle to the chamber and back to the bottle.

2. The apparatus for aerating and filtering wine from the bottle of claim 1, wherein the chamber is partially defined by a removable cap.

3. The apparatus for aerating and filtering wine from the bottle of claim 1, wherein the first end flexes to accommodate the bottle.

4. The apparatus for aerating and filtering wine from the bottle of claim 1, wherein the second end has a flat surface for supporting the bottle when the bottle is inverted.

5. The apparatus for aerating and filtering wine from the bottle of claim 1, wherein the chamber is at least 750 ml in volume.

6. The apparatus for aerating and filtering wine from a bottle of claim 1, wherein at least the intermediate portion defines a first channel for the passage of wine and a second channel for the passage of air.

7. The apparatus for aerating and filtering wine from a bottle of claim 1, wherein the first end, the second end and the intermediate portion are unitarily formed of plastic.

8. The apparatus for aerating and filtering wine from a bottle of claim 1, wherein the first end includes a pair of spaced apart arms.

9. The apparatus for aerating and filtering wine from a bottle of claim 6, wherein the first and second channels cooperate to define a longitudinally extending opening, the longitudinally extending opening having a generally circular cross section, the generally circular cross section being equally divided by a longitudinally extending wall.

10. An apparatus for aerating and filtering wine from a bottle, the apparatus comprising:
a first end for receipt in an opening of the bottle;
a second end for receipt in an opening of a secondary container; and
a central portion for filtering and aerating the wine as the wine passes therethrough.

11. The apparatus for aerating and filtering wine from the bottle of claim 10, wherein at least the central portion defines a first channel for the passage of wine and a second channel for the passage of air.

12. The apparatus for aerating and filtering wine from a bottle of claim 10, wherein the first end, the second end and the central portion are unitarily constructed.

13. The apparatus for aerating and filtering wine from a bottle of claim 10, wherein the first end, the second end and the central portion are unitarily constructed of plastic.

14. The apparatus for aerating and filtering wine from a bottle of claim 11, wherein the first and second channels are generally parallel to one another.

15. The apparatus for aerating and filtering wine from a bottle of claim 11, wherein the first and second channels cooperate to define a longitudinally extending opening, the longitudinally extending opening having a generally circular cross section, the generally circular cross section being equally divided by a longitudinally extending wall.

16. A method for aerating and filtering wine from a bottle, the method comprising:
providing an apparatus including a first end, a second end, and an intermediate portion therebetween;
engaging the first end with the wine bottle;
engaging the second end with a secondary container; and
transferring the wine from the bottle through the apparatus and to the secondary container so as to filter and aerate the wine as the wine passes through the apparatus.

17. The method for aerating and filtering wine from the bottle of claim 16, further comprising transferring the wine from the secondary container, through the apparatus and back to the bottle.

18. The method for aerating and filtering wine from the bottle of claim 16, wherein the second end of the apparatus is formed to define the secondary container.

19. The method for aerating and filtering wine from a bottle of claim 16, wherein at least the intermediate portion defines a first channel for the passage of wine and a second channel for the passage of air.

20. The method for aerating and filtering wine from a bottle of claim 16, wherein the first and second channels cooperate to define a longitudinally extending opening, the longitudinally extending opening having a generally circular cross section, the generally circular cross section being equally divided by a longitudinally extending wall.
